(19) United States
(12) Patent Application Publication
(10) Pub. No.: US 2021/0224484 A1
(43) Pub. Date: Jul. 22, 2021

(54) SUMMARY GENERATION APPARATUS, SUMMARY GENERATION METHOD, AND NON-TRANSITORY COMPUTER-READABLE STORAGE MEDIUM

(71) Applicant: SHARP KABUSHIKI KAISHA, Osaka (JP)

(72) Inventor: TOMOYUKI KAWASOE, Osaka (JP)

(21) Appl. No.: 17/147,994

(22) Filed: Jan. 13, 2021

(30) Foreign Application Priority Data
Jan. 20, 2020 (JP) 2020-006925

(51) Int. Cl. G06F 40/30; G06F 40/166

(52) U.S. Cl. CPC G06F 40/30; G06F 16/22; G06F 40/166

(57) ABSTRACT

Generation apparatus includes: a knowledge estimation unit estimating user knowledge in accordance with a knowledge estimation rule for estimating that a user has knowledge; a sentence obtainment unit obtaining a sentence to be summarized; a sentence summarization unit summarizing the sentence obtained by the sentence obtainment unit to obtain a summary candidate word as a result of the summarization; and a summary word generation unit generating a summary word to be output to the user in accordance with the user knowledge estimated by the knowledge estimation unit and the summary candidate word obtained by the sentence summarization unit.

### CROSS-REFERENCE TO RELATED APPLICATION

The present application claims priority from Japanese Application JP2020-006925, the content of which is hereby incorporated by reference into this application.

### BACKGROUND OF THE INVENTION

### 1. Field of the Invention

An aspect of the present invention relates to a summary generation apparatus, a summary generation method, and a non-transitory computer-readable storage medium.

Japanese Unexamined Patent Application Publication No. 2005-301584 discloses a technique for selecting an article that matches preference of a user using a distribution service of summarized articles while eliminating the need of the user registering the preference, and creating a summary of the selected article so that the summary suits the preference of the user. The publication also discloses that the summary is created in accordance with a summary rate indicating a ratio of a length of a sentence of an article to be summarized to a length of a sentence of the summary of the article to be created.

### SUMMARY OF THE INVENTION

If the user is in a hurry, however, even the summarized sentence created in accordance with the summary rate might be lengthy and time-consuming to read for the user.

In view of the above problem, an aspect of the present invention is to provide a summary generation apparatus, a summary generation method, and a non-transitory computer-readable storage medium capable of generating a summary of a sentence more precisely.

A summary generation apparatus according to an aspect of the present invention includes: a knowledge estimation unit estimating user knowledge in accordance with a knowledge estimation rule for estimating that a user has knowledge; a sentence obtainment unit obtaining a sentence to be summarized; a sentence summarization unit summarizing the sentence obtained by the sentence obtainment unit to obtain a summary candidate word as a result of the summarization; and a summary word generation unit generating a summary word to be output to the user in accordance with the user knowledge estimated by the knowledge estimation unit and the summary candidate word obtained by the sentence summarization unit.

A summary generation method according to another aspect of the present invention is executed by a summary generation apparatus. The summary generation method includes: estimating, by the summary generation apparatus, user knowledge in accordance with a knowledge estimation rule for estimating that a user has knowledge; obtaining, by the summary generation apparatus, a sentence to be summarized; summarizing, by the summary generation apparatus, the sentence to obtain a summary candidate word as a result of the summarization; and generating, by the summary generation apparatus, a summary word to be output to the user in accordance with the user knowledge and the summary candidate word.

A non-transitory computer-readable storage medium according to still another aspect of the present invention contains a program causing a computer to execute: estimating user knowledge in accordance with a knowledge estimation rule for estimating that a user has knowledge; obtaining a sentence to be summarized; summarizing the sentence to obtain a summary candidate word as a result of the summarization; and generating a summary word to be output to the user in accordance with the user knowledge and the summary candidate word.

An aspect of the present invention makes it possible to generate a summary of a sentence more precisely.

### BRIEF DESCRIPTION OF THE DRAWINGS

FIG. 1 is a block diagram illustrating an example of an overall configuration of a system, for generating a summary, according to a first embodiment;

FIG. 2 is a block diagram illustrating an example of a hardware configuration of a mobile terminal according to the first embodiment;

FIG. 3 is a block diagram illustrating an example of a functional configuration of the mobile terminal according to the first embodiment;

FIG. 4 is a flowchart showing an example of a method, for estimating user knowledge, included in a summary generation method according to the first embodiment;

FIG. 5 is a flowchart showing another example of the method, for estimating user knowledge, included in the summary generation method according to the first embodiment;

FIG. 6 is a flowchart showing an example of a method, for generating a summary word, included in the summary generation method according to the first embodiment;

FIG. 7 is a block diagram illustrating an example of an overall configuration of a system, for generating a summary, according to a second embodiment;

FIG. 8 is a block diagram illustrating an example of a functional configuration of a mobile terminal according to the second embodiment;

FIG. 9 is a block diagram illustrating an example of a hardware configuration of a summary generation server according to the second embodiment;

FIG. 10 is a block diagram illustrating an example of a functional configuration of the summary generation server according to the second embodiment;

FIG. 11 is a flowchart showing an example of a method, for estimating user knowledge, included in a summary generation method according to the second embodiment;

FIG. 12 is a flowchart showing another example of the method, for estimating user knowledge, included in the summary generation method according to the second embodiment; and

FIG. 13 is a flowchart showing an example of a method, for generating a summary word, included in the summary generation method according to the second embodiment.

### DETAILED DESCRIPTION OF THE INVENTION

Described below are embodiments of the present invention, with reference to the drawings. The embodiments described below are just examples, and thus any embodiment to which the present invention is applicable shall not be limited to those embodiments.

### First Embodiment

Configuration of System

FIG. 1 is a block diagram illustrating an example of an overall configuration of a system 100, for generating a summary, according to a first embodiment. As illustrated in FIG. 1, the system 100 includes: a mobile terminal 110; a network 120; and a sentence distribution server 130.

The mobile terminal 110, an example of a summary generation apparatus, may be such a computer device as a smartphone and a tablet terminal.

The network 120 includes, for example, a mobile communications network, a local area network (LAN), a wide area network (WAN), the Internet, and a combination of these networks.

The sentence distribution server 130 may be a server computer distributing a sentence to the mobile terminal 110. Such a sentence is of, for example, a news article and an announcement of an event.

The mobile terminal 110 requests the sentence distribution server 130 a sentence through the network 120. In response to the request, the sentence distribution server 130 distributes the requested sentence to the mobile terminal 110 through the network 120. Moreover, the sentence distribution server 130 can periodically distribute a sentence to the mobile terminal 110 through the network 120. The mobile terminal 110 generates a summary word of a sentence distributed from the sentence distribution server 130, and outputs the summary word to a user of the mobile terminal 110.

Configuration of Mobile Terminal 110

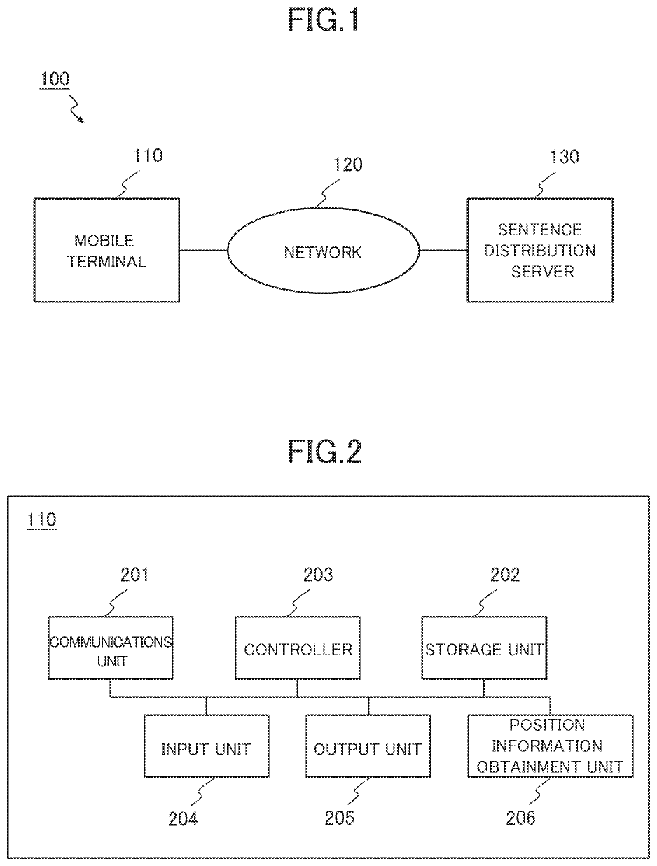

FIG. 2 is a block diagram illustrating an example of a hardware configuration of the mobile terminal 110 according to the first embodiment. As illustrated in FIG. 2, the mobile terminal 110 includes: a communications unit 201; a storage unit 202; a controller 203; an input unit 204; an output unit 205; and a position information obtainment unit 206.

The communications unit 201 includes an interface device for such communications as mobile communications (e.g., 4G and 5G) and wireless LAN communications, and communicates with another appliance such as the sentence distribution server 130 through the network 120.

The storage unit 202 includes: a memory (e.g., a dynamic random access memory (DRAM) and a static random access memory (SRAM)); a hard disk; and a flash memory card, and stores such a program and a datum as an operating system and an application.

The controller 203 includes a central processing unit (CPU), and executes the program stored in the storage unit 202 and controls an overall operation of the mobile terminal 110.

The input unit 204 includes: a physical keyboard; a touch panel; and a microphone, and receives an input from the user.

The output unit 205 includes: a display; and a speaker, and outputs to the user such a message as a summary word to be generated in this embodiment.

The position information obtainment unit 206 includes such a positioner as a global positioning system (GPS), and obtains position information on the mobile terminal 110. The position information includes, for example, latitude-longitude information and address information. The address information is obtained in accordance with latitude and longitude information from a data base storing the address information and the latitude-longitude information associated with each other.

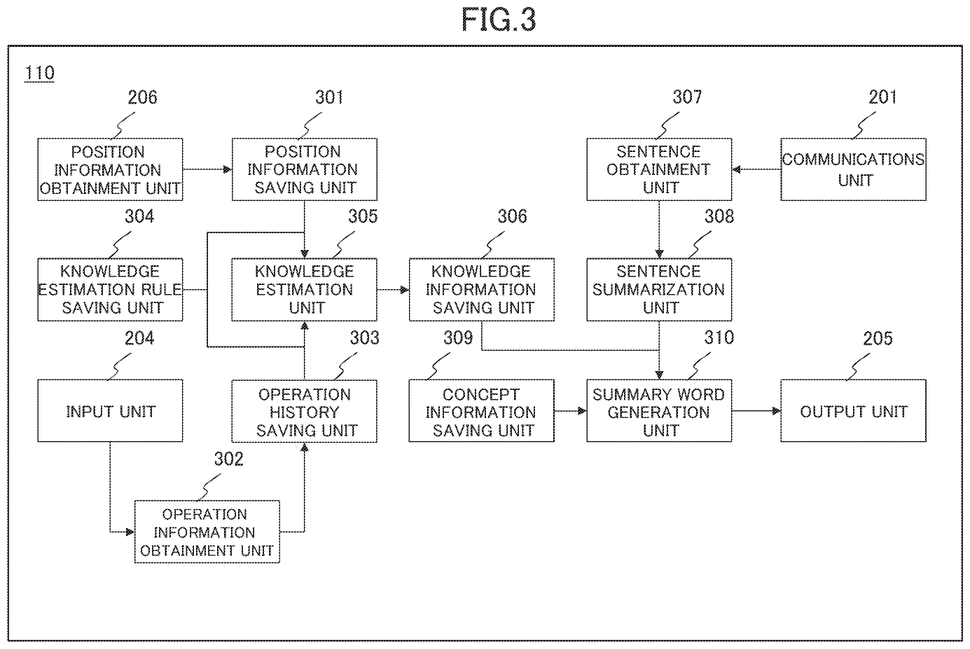

FIG. 3 is a block diagram illustrating an example of a functional configuration of the mobile terminal 110 according to the first embodiment. As functional units, the mobile terminal 110 includes: the communications unit 201; the input unit 204; the output unit 205; the position information obtainment unit 206; a position information saving unit 301; an operation information obtainment unit 302; an operation history saving unit 303; a knowledge estimation rule saving unit 304; a knowledge estimation unit 305; and a knowledge information saving unit 306. As functional units, the mobile terminal 110 further includes: a sentence obtainment unit 307; a sentence summarization unit 308; a concept information saving unit 309; and a summary word generation unit 310.

The communications unit 201 described above communicates with another appliance such as the sentence distribution server 130 through the network 120.

The input unit 204 described above receives an input from the user.

The output unit 205 described above outputs, to the user, such a message as a summary word.

The position information obtainment unit 206 described above obtains position information on the mobile terminal 110, such as latitude-longitude information and address information. The position information obtainment unit 206 then saves, on the position information saving unit 301, the position information together with date-time information indicating the date and time when the position information is obtained.

The position information saving unit 301 saves the position information and the date-time information obtained by the position information obtainment unit 206.

When an operation is performed through the input unit 204, the operation information obtainment unit 302 obtains information on the operation (operation information), and saves on the operation history saving unit 303 the operation information together with date-time information indicating the date and time when the operation information is obtained. Such an operation includes, for example, startup of an application, viewing a web site and reading a news article, and posting on a social networking service (SNS).

The operation history saving unit 303 saves the operation information and the date-time information obtained by the operation information obtainment unit 302.

The knowledge estimation rule saving unit 304 saves a knowledge estimation rule previously set by such a party as a provider of a summary generation program described in, for example, the present disclosure. The knowledge estimation rule may be updated on the knowledge estimation rule saving unit 304, for example, for every time the provider updates the rule. The knowledge estimation rule will be described in detail later.

The knowledge estimation unit 305 estimates knowledge of the user (knowledge information), using the knowledge estimation rule saved on the knowledge estimation rule saving unit 304, and saves the estimated knowledge information on the knowledge information saving unit 306. How to estimate the user knowledge will be described in detail later.

The knowledge information saving unit 306 saves the knowledge information estimated by the knowledge estimation unit 305.

The sentence obtainment unit 307 obtains a sentence distributed from the sentence distribution server 130 through the communications unit 201.

The sentence summarization unit 308 summarizes the sentence obtained by the sentence obtainment unit 307, and outputs, to the summary word generation unit 310, a summary candidate word as a result of the summarization. Such a summary candidate word in this embodiment is, for example, a single word or phrase. Taking into consideration a case where the user desires more information, the user may set, for example, the number of summary candidate words. The processing on the sentence summarization unit 308; that is, summarizing the sentence and outputting the summary candidate word, may involve, for example, calculating, using a set of sentences previously prepared, term frequency-inverse document frequency (TF-IDF) scores of words or phrases contained in the sentence obtained by the sentence obtainment unit 307, and obtaining to output a word or a phrase having the highest TF-IDF score as the summary candidate. If two or more words or phrases have the highest TF-IDF score, the sentence summarization unit 308 may, for example, select one of the words or phrases at random. How to calculate TF-IDF scores is well known, and the description thereof will not be elaborated upon here.

The concept information saving unit 309 saves hypernymy information previously set by such a party as the above provider. The hypernymy information may be updated on the concept information saving unit 309, for example, for every time the provider updates the information. The hypernymy information will be described in detail later.

The summary word generation unit 310 generates a summary word to be provided for the user, using such information as the summary candidate word generated by the sentence summarization unit 308, the knowledge information saved on the knowledge information saving unit 306, and the hypernymy information saved on the concept information saving unit 309, and outputs the generated summary word to the output unit 205.

Each of the operation information obtainment unit 302, the knowledge estimation unit 305, the sentence obtainment unit 307, the sentence summarization unit 308, and the summary word generation unit 310 may be a program module implemented by, for example, the controller 203 executing a summary generation program stored in the storage unit 202. Moreover, the position information saving unit 301, the operation history saving unit 303, the knowledge estimation rule saving unit 304, the knowledge information saving unit 306, and the concept information saving unit 309 may be included in, for example, the storage unit 202 as appropriate. Alternatively, these functional units may be implemented by a logic circuit (hardware) fabricated, for example, in the form of an integrated circuit (an IC chip). Each of the functional units may be implemented by one or more integrated circuits. Two or more of such functional circuits may be implemented by a single integrated circuit.

### Knowledge Estimation Rule and How to Estimate User Knowledge

The knowledge estimation rule is for estimating user knowledge by the knowledge estimation unit 305, using such information as the position information saved on the position information saving unit 301 and the operation information saved on the operation history saving unit 303. Table 1 below shows an example of the knowledge estimation rule.

TABLE 1
Example of Knowledge Estimation Rule

| No. | Condition | Knowledge |
|---|---|---|
| 1 | Position information is “Prefecture A.” | Prefecture A |
| 2 | Position information is “City B.” | City B |
| 3 | Position information is “Park C” | Park C |
| 4 | Position information is “Ball Park D”, and | Team E |
| | “Team E” has a game on a date when | |
| | the position information is obtained. | |
| 5 | Position information is “Ball Park D”, and | Artist F |
| | “Artist F” has a concert on a date when | |
| | the position information is obtained. | |
| 6 | “Application G” in the mobile terminal | Application G |
| | is activated. | |
| 7 | Searching for “Statesperson H” with | Statesperson H |
| | the mobile terminal. | |
| 8 | Viewing an official website of “Company I” | Company I |
| | with the mobile terminal. | |
| 9 | Viewing news of “Sport J” with the mobile | Sport J |
| | terminal. | |
| 10 | Posting on an SNS about “Entertainer K” | Entertainer K |
| | with the mobile terminal. | |

Described below is processing on the knowledge estimation unit 305, with reference to the above example of the knowledge estimation rule.

As Nos. 1 to 3 of Table 1 show, the knowledge estimation unit 305 can estimate that the user knows the names of the places and the facilities when the position information indicates, for example, names of places and facilities.

Moreover, as Nos. 4 and 5 of Table 1 show, the knowledge estimation unit 305 can estimate an event that the user joined, and a target and an object of the event, using the position information and, additionally, date-time information and event information obtained when the position information is obtained.

Moreover, as Nos. 6 to 10 of Table 1 show, the knowledge estimation unit 305 can estimate knowledge of the user (e.g., the user knows an application G and a statesperson H) from the operation history of (the operation information on) the mobile terminal 110 including histories of application startups, searches, viewing web sites and reading news articles, and posting on an SNS.

As can be seen, the knowledge estimation rule is a rule for estimating that user has the knowledge if a predetermined condition is met. Moreover, if the position information saved on the position information saving unit 301 and the operation information saved on the operation history saving unit 303 satisfy any one of the conditions in the “condition” column in Table 1, the knowledge estimation unit 305 estimates user knowledge associated with the one condition in the “condition” column in Table 1.

Note that the above position information may be latitude-longitude information or address information such as “‘Street 1-1’, ‘Town L’, ‘City C’, ‘Prefecture A’.”

In determining knowledge using the knowledge estimation rule, in the case where the latitude-longitude information is used as a method for determining that the position information is on “Park C”, the knowledge estimation unit 305 determines that the position information is on “Park C” when, for example, the distance between the latitude and longitude of Park C and the latitude and longitude in the position information is calculated and the calculated distance is equal to a predetermined value or shorter. Moreover, in the case where the address information is used as a method for determining that the position information is on “Park C”, the knowledge estimation unit 305 determines that the position information is on “Park C” when, for example, the address information on “Park C” matches the address information in the position information.

Furthermore, in estimating knowledge using these knowledge estimation rules, the knowledge estimation unit 305 does not necessarily estimate, depending on a condition, that the user has the knowledge when the condition is met once. Alternatively, the knowledge estimation unit 305 may estimate that the user has the knowledge when the condition is met together with such additional conditions as “the condition is met for several days” and “the condition is met certain times for a certain time period.”

As a matter of course, the knowledge estimation rules shall not be limited to the above examples.

Hypernymy Information

The hypernymy information includes a pair of: a word to be a target (i.e., a target word: a first word); and a word representing a hypernymy of the target word (a hypernym: a second word). The hypernymy information is referred to by the summary word generation unit 310 when the summary word generation unit 310 generates a summary word. Table 2 below shows an example of the hypernymy information.

TABLE 2
Example of Hypernymy Information

| No. | Target Word | Hypernym |
|---|---|---|
| 1 | City L | Prefecture M |
| 2 | Artist N | Group O |
| 3 | Athlete P | Sport Team Q |
| 4 | Sport Team R | Sport S |
| 5 | Product T | Company U |
| 6 | Novel V | Author W |

Described below is an example of a relationship between a target word and a hypernym, with reference to the example of the above hypernymy information.

As No. 1 of Table 2 shows, the relationship between a target word and a hypernym may be an inclusion relationship between names of places. For example, when “City L” is in “Prefecture M”, “Prefecture M” is a hypernymy of “City L”.

As No. 2 of Table 2 shows, the relationship between a target word and a hypernym may be a relationship between a group and a member of the group. For example, if “Artist N” is a member of “Group O”, “Group O” is a hypernymy of “Artist N.”

As No. 3 of Table 2 shows, the relationship between a target word and a hypernym may be a relationship between a sport team and an athlete of the sport team. For example, if “Athlete P” belongs to “Sport Team Q”, “Sport Team Q” is a hypernymy of “Athlete P.”

As No. 4 of Table 2 shows, the relationship between a target word and a hypernym may be a relationship between a sport and a sport team which involves the sport. For example, if “Sport Team R” involves in “Sport S”, “Sport S” is a hypernymy of “Sport Team R.”

As No. 5 of Table 2 shows, the relationship between a target word and a hypernym may be a relationship between a company and a product of the company. For example, if “Product T” is a product of “Company U”, “Company U” is a hypernymy of “Product T.”

As No. 6 of Table 2 shows, the relationship between a target word and a hypernym may be a relationship between a creator and a work of the creator. For example, if “Author W” is an author of “Novel V”, “Author W” is a hypernymy of “Novel V.”

As above Nos. 3 and 4 show, when a target word has a hypernym, the hypernym can also have a hypernym (if “Sport Team Q” and “Sport Team R” are the same team).

As a matter of course, the hypernymy information shall not be limited to the above examples.

Operation of Mobile Terminal 110

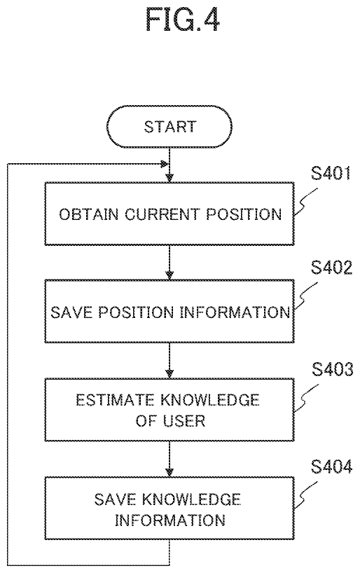

Described next is an operation of the mobile terminal 110, with reference to FIGS. 4 to 6.

FIG. 4 is a flowchart showing an example of a method, for estimating user knowledge, included in a summary generation method according to the first embodiment. This method for estimating user knowledge involves estimating knowledge of a user, using position information on the mobile terminal 110.

At S401, the position information obtainment unit 206 obtains a current position of the mobile terminal 110.

Next, at S402, the position information obtainment unit 206 saves, on the position information saving unit 301, information on the obtained current position (position information) together with date-time information indicating when the position information is obtained.

At S403, the knowledge estimation unit 305 estimates knowledge of the user (knowledge information) in accordance at least with the position information saved on the position information saving unit 301 and a knowledge estimation rule saved on the knowledge estimation rule saving unit 304.

Next, at S404, the knowledge estimation unit 305 saves, on the knowledge information saving unit 306, the estimated knowledge information.

The mobile terminal 110 periodically repeats (e.g., every one minute or every one hour) the processes of S401 to S404 to accumulate the knowledge information in the knowledge information saving unit 306.

Note that the processes of S401 and S402 and the processes of S403 and S404 may be performed separately. For example, the processes of S401 and S402 may be performed every one minute, and the processes of S403 and S404 may be performed every one hour.

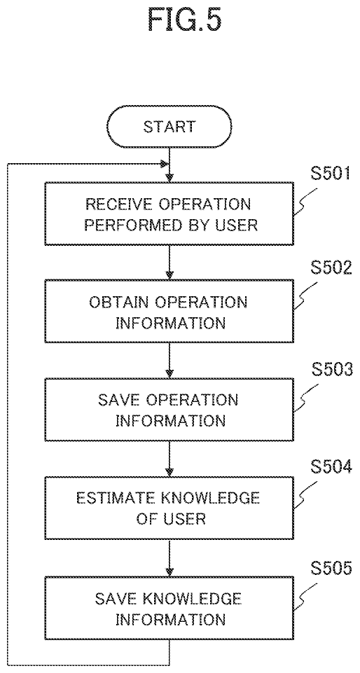

FIG. 5 is a flowchart showing another example of the method, for estimating user knowledge, included in the summary generation method according to the first embodiment. This method for estimating user knowledge involves estimating knowledge of a user, using information on an operation of the mobile terminal 110 performed by the user.

At S501, the user operates the mobile terminal 110, using the input unit 204. That is, the input unit 204 receives an operation performed by the user.

Next, at S502, the operation information obtainment unit 302 obtains information on the operation performed with the input unit 204 (operation information). At S503, the operation information obtainment unit 302 saves, on the operation history saving unit 303, the obtained operation information together with date-time information indicating when the operation information is obtained.

At S504, the knowledge estimation unit 305 estimates knowledge of the user (knowledge information) in accordance at least with the operation information saved on the operation history saving unit 303 and a knowledge estimation rule saved on the knowledge estimation rule saving unit 304.

Next, at S505, the knowledge estimation unit 305 saves, on the knowledge information saving unit 306, the estimated knowledge information.

The mobile terminal 110 performs processes of S501 to S503 every time the user operates the mobile terminal 110 using the input unit 204, and periodically repeats (e.g., every one minute or every one hour) the processes of S504 and S505 to accumulate the knowledge information in the knowledge information saving unit 306.

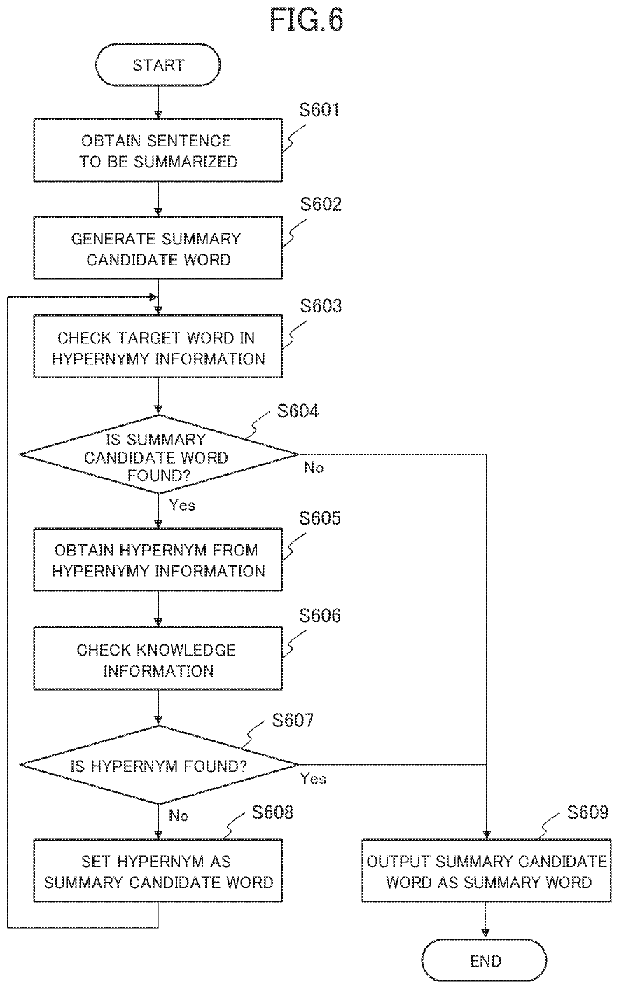

FIG. 6 is a flowchart showing an example of a method, for generating a summary word, included in the summary generation method according to the first embodiment.

At S601, the sentence obtainment unit 307 obtains a sentence distributed to be summarized from the sentence distribution server 130 through the communications unit 201, and outputs the sentence to the sentence summarization unit 308.

At S602, as described above, the sentence summarization unit 308 summarizes the sentence obtained by the sentence obtainment unit 307, and outputs, to the summary word generation unit 310, a summary candidate word as a result of the summarization.

At S603, the summary word generation unit 310 checks whether the summary candidate word is found as a target word in hypernymy information saved on the concept information saving unit 309.

If the summary candidate word is not found as a target word in the hypernymy information (No at S604), the summary word generation unit 310 at S609 sets the summary candidate word as a summary word, and outputs the summary word to the output unit 205. The output unit 205 outputs to the user the summary word as, for example, display information and/or audio information.

If the summary candidate word is found as a target word in the hypernymy information (Yes at S604), the summary word generation unit 310 at S605 obtains a hypernym of the target word from the hypernymy information.

At S606, the summary word generation unit 310 checks whether the obtained hypernym is found as knowledge information saved on the knowledge information saving unit 306.

If the hypernym is found as the knowledge information (Yes at S607), the summary word generation unit 310 at S609 sets the summary candidate word as a summary word, and outputs the summary word to the output unit 205. The output unit 205 outputs the summary word as, for example, display information and/or audio information.

If the hypernym is not found as the knowledge information (No at S607), the summary word generation unit 310 at S608 sets the hypernym as a new summary candidate word. After that, the summary word generation unit 310 performs the processes from S603 again.

Described below are four examples of how to set and output a summary candidate word and a summary word, with reference to the example of the hypernymy information shown in Table 2.

Example 1 shows a case where the summary candidate word is “Athlete P′.”

“Athlete P′” is not found as a target word in the hypernymy information. At Step 604, the summary word generation unit 310 determines “No”, and Athlete P′ is output to the user.

Example 2 shows a case where the summary candidate word is “Athlete P”, and “Sport Team Q” is found in the knowledge information.

“Athlete P” is found as a target word in the hypernymy information. At S604, the summary word generation unit 310 determines “Yes”, and the corresponding hypernym “Sport Team Q” is obtained.

“Sport Team Q” is found in the knowledge information. At S607, the summary word generation unit 310 determines “Yes”, and “Athlete P” is output to the user.

Example 3 shows a case where, in Table 2, “Sport Team Q” and “Sport Team R” are the same team, the summary candidate word is “Athlete P”, “Sport Team Q” is not found in the knowledge information, and “Sport S” is found in the knowledge information.

“Athlete P” is found as a target word in the hypernymy information. At S604, the summary word generation unit 310 determines “Yes”, and the corresponding hypernym “Sport Team Q” is obtained.

“Sport Team Q” is not found in the knowledge information. At S607, the summary word generation unit 310 determines “No”, and “Sport Team Q” is set as a new summary candidate word.

“Sport Team Q” is found as a target word in the hypernymy information. At S604, the summary word generation unit 310 determines “Yes”, and the corresponding hypernym “Sport S” is obtained.

“Sport S” is found in the knowledge information. At S607, the summary word generation unit 310 determines “Yes”, and “Sport Team Q” is output to the user.

Example 4 is a case where, in Table 2, “Sport Team Q” and “Sport Team R” are the same team, the summary candidate word is “Athlete P”, and neither “Sport Team Q” nor “Sport S” is found in the knowledge information.

“Athlete P” is found as a target word in the hypernymy information. At S604, the summary word generation unit 310 determines “Yes”, and the corresponding hypernym “Sport Team Q” is obtained.

“Sport Team Q” is not found in the knowledge information. At S607, the summary word generation unit 310 determines “No”, and “Sport Team Q” is set as a new summary candidate word.

“Sport Team Q” is found as a target word in the hypernymy information. At S604, the summary word generation unit 310 determines “Yes”, and the corresponding hypernym “Sport S” is obtained.

“Sport S” is not found in the knowledge information. At S607, the summary word generation unit 310 determines “No”, and “Sport S” is set as a new summary candidate word.

“Sport S” is not found as a target word in the hypernymy information. At Step 604, the summary word generation unit 310 determines “No”, and “Sport S” is output to the user.

If the above Examples continue and a news article about “Athlete P” is found, for example, the summary word of the news article is set and output as described below.

(1) As described in Example 2, suppose a case where the user knows well about “Sport Team Q” to which “Athlete P” belongs. Even if “Athlete P” is output as it is as a summary word, the user is likely to understand the summary word. Hence, “Athlete P” is set as the summary word and output.

(2) As described in Example 3, suppose a case where the user does not know well about “Sport Team Q” but knows well about “Sport S” in which “Sport Team Q” involves. If “Athlete P” is output as it is as a summary word, the user is not likely to understand the summary word. However, if “Sport Team Q” is output as the summary word, the user is likely to understand the summary word. Hence, “Sport Team Q” is set as the summary word and output.

(3) As described in Example 4, suppose a case where the user does not know well about “Sport Team Q” or “Sport S”. The user is not likely to understand “Athlete P or “Sport Team Q”, so that “Sport S” is set as a summary word and output.

Thanks to the features of the first embodiment, one summary word is generated out of a sentence so that a summary of the sentence can be precisely generated. Hence, in accordance with levels of interest in output summary words of two or more sentences (such as news articles), the user can prioritize the sentences Thanks to the features in particular of the knowledge information and the hypernymy information of the first embodiment, summary words can be changed depending on the knowledge of the user.

### Second Embodiment

Configuration of System

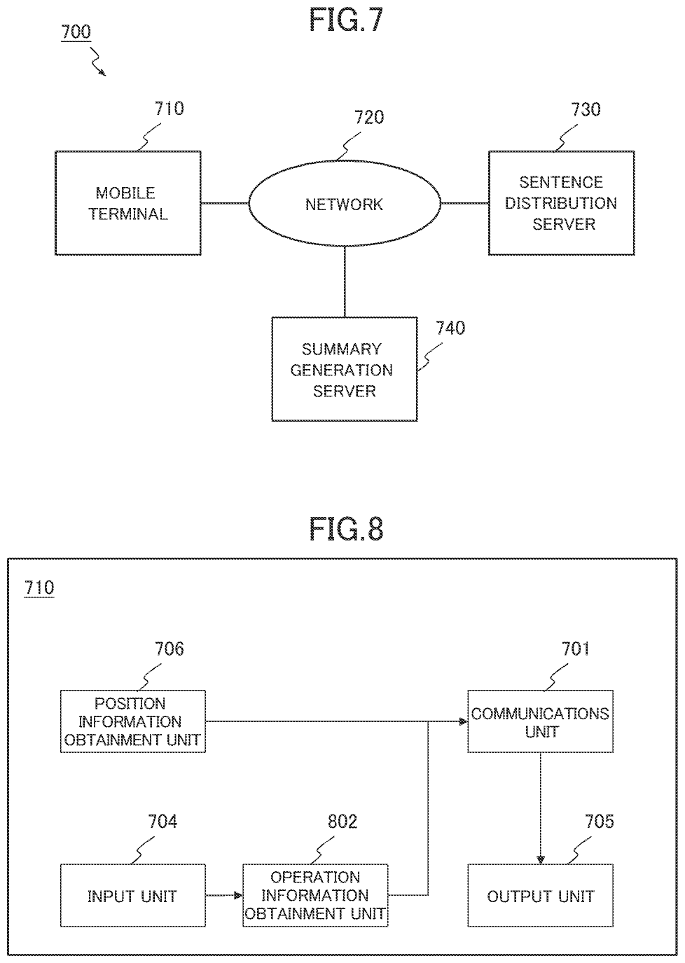

FIG. 7 is a block diagram illustrating an example of an overall configuration of a system 700, for generating a summary, according to a second embodiment. As illustrated in FIG. 7, the system 700 includes: a mobile terminal 710; a network 720; a sentence distribution server 730; and a summary generation server 740.

The mobile terminal 710 may be such a computer device as a smartphone and a tablet terminal.

The network 720 includes, for example, a mobile communications network, a local area network (LAN), a wide area network (WAN), the Internet, and a combination of these networks.

The sentence distribution server 730 may be a server computer distributing a sentence to the summary generation server 740. Such a sentence is of, for example, a news article and an announcement of an event.

The summary generation server 740, an example of a summary generation unit, may be a server computer generating a summary word of a sentence to be distributed from the sentence distribution server 730, and transmitting the summary word to the mobile terminal 710.

The mobile terminal 710 requests the sentence distribution server 730 a sentence through the network 720 and the sentence generation server 740. In response to the request, the sentence distribution server 730 distributes the requested sentence to the sentence generation server 740 through the network 720. Next, the summary generation server 740 generates a summary word of the sentence distributed from the sentence distribution server 730, and transmits the summary word to the mobile terminal 710. The mobile terminal 710 outputs the summary word to a user of the mobile terminal 710. Moreover, the sentence distribution server 730 can periodically distribute a sentence to the summary generation server 740 through the network 720. The summary generation server 740 can generate a summary word of the sentence periodically distributed from the sentence distribution server 730, and transmit the summary word to the mobile terminal 710.

Configuration of Mobile Terminal 710

The mobile terminal 710 according to the second embodiment is the same in hardware configuration as the mobile terminal 110 described before, and the hardware configuration of the mobile terminal 710 will not be elaborated upon here.

FIG. 8 is a block diagram illustrating an example of a functional configuration of the mobile terminal 710 according to the second embodiment. As functional units, the mobile terminal 710 includes: a communications unit 701; an input unit 704; an output unit 705; a position information obtainment unit 706; and an operation information obtainment unit 802.

The communications unit 701 communicates with another appliance such as the summary generation server 740 through the network 720.

The input unit 704 receives an input from the user.

The output unit 705 outputs to the user such a message as a summary word.

The position information obtainment unit 706 obtains position information on the mobile terminal 710, such as latitude-longitude information and address information. Through the communications unit 701, the position information obtainment unit 706 transmits to the summary generation server 740 the position information together with such information as date-time information indicating the date and time when the position information is obtained and identification information for identifying the mobile terminal 710 and the user.

When an operation is performed through the input unit 704, the operation information obtainment unit 802 obtains information on the operation (operation information), and transmits to the summary generation server 740 the operation information together with such information as date-time information indicating the date and time when the operation information is obtained and identification information for identifying the mobile terminal 710 and the user.

The operation information obtainment unit 802 is, for example, a program module implemented by a not-shown controller of the mobile terminal 710 executing a program stored in a not-shown storage unit of the mobile terminal 710. Alternatively, the operation information obtainment unit 802 may be implemented by a logic circuit (hardware) fabricated, for example, in the form of an integrated circuit (an IC chip). The operation information obtainment unit 802 may also be implemented by one or more integrated circuits.

Configuration of Summary Generation Server 740

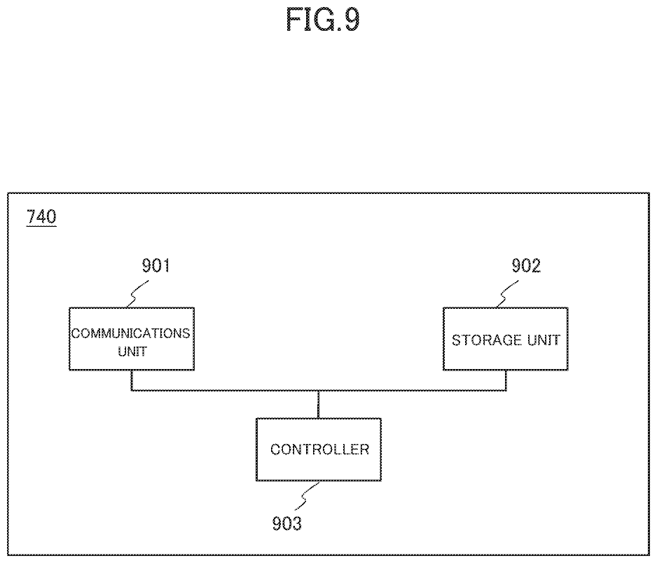

FIG. 9 is a block diagram illustrating an example of a hardware configuration of the summary generation server 740 according to the second embodiment. As illustrated in FIG. 9, the summary generation server 740 includes: a communications unit 901; a storage unit 902; and a controller 903.

The communications unit 901 includes an interface device for such communications as mobile communications (e.g., 4G and 5G) and wireless LAN communications, and communicates with another appliance such as the mobile terminal 710 and the sentence distribution server 730 through the network 720.

The storage unit 902 includes a memory (e.g., a DRAM and an SRAM), a hard disk, and a flash memory card, and stores such a program and a datum as an operating system and an application.

The controller 903 includes a central processing unit (CPU), and executes the program stored in the storage unit 902 and controls an overall operation of the summary generation server 740.

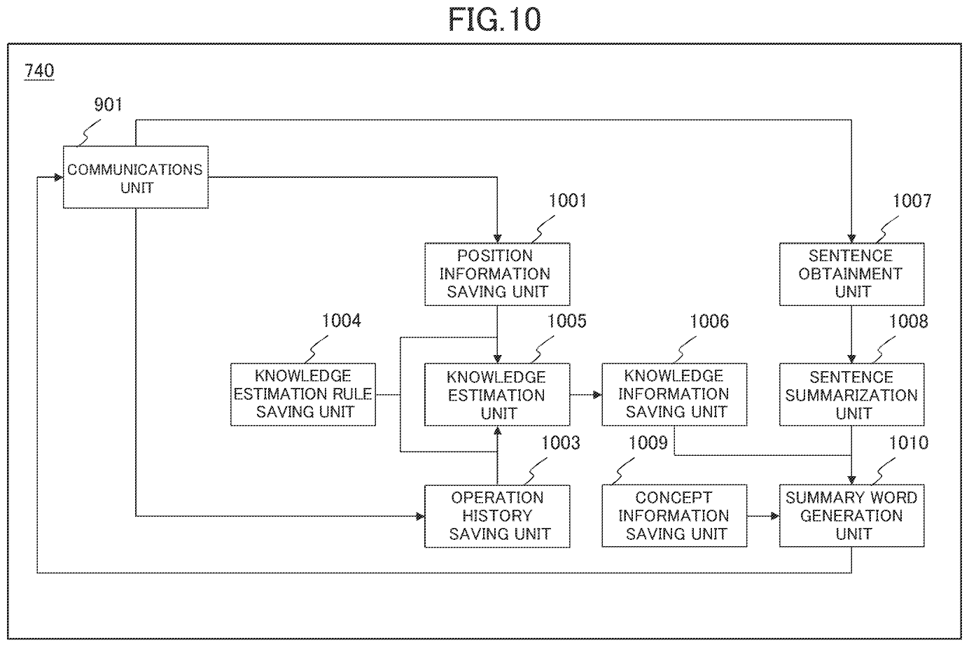

FIG. 10 is a block diagram illustrating an example of a functional configuration of the summary generation server 740 according to the second embodiment. As functional units, the summary generation server 740 includes: the communications unit 901; a position information saving unit 1001; an operation history saving unit 1003; a knowledge estimation rule saving unit 1004; a knowledge estimation unit 1005; a knowledge information saving unit 1006; a sentence obtainment unit 1007; a sentence summarization unit 1008; a concept information saving unit 1009; and a summary word generation unit 1010.

The communications unit 901 described above communicates with another appliance such as the mobile terminal 710 and the sentence distribution server 730 through the network 720.

The position information saving unit 1001 saves such information as position information, date-time information, and identification information received from the mobile terminal 710 through the communications unit 901.

The operation history saving unit 1003 saves such information as operation information, date-time information, and identification information received from the mobile terminal 710 through the communications unit 901.

The knowledge estimation rule saving unit 1004 saves a knowledge estimation rule previously set in a similar manner as the above knowledge estimation rule with reference to, for example, Table. 1.

The knowledge estimation unit 1005 estimates knowledge of the user (knowledge information), using the knowledge estimation rule saved on the knowledge estimation rule saving unit 1004, and saves, on the knowledge information saving unit 1006, the estimated knowledge information.

The knowledge information saving unit 1006 saves the knowledge information estimated by the knowledge estimation unit 1005.

The sentence obtainment unit 1007 obtains a sentence distributed from the sentence distribution server 730 through the communications unit 901.

The sentence summarization unit 1008 summarizes the sentence obtained by the sentence obtainment unit 1007, and outputs, to the summary word generation unit 1010, a candidate summary word as a result of the summarization. The sentence is summarized as described before.

The concept information saving unit 1009 saves hypernymy information previously set in a similar manner as the above hypernymy information with reference to, for example, Table 2.

The summary word generation unit 1010 generates a summary word to be provided for the user, using such information as the summary candidate word generated by the sentence summarization unit 1008, the knowledge information saved on the knowledge information saving unit 1006, and the hypernymy information saved on the concept information saving unit 1009, and transmits the generated summary word to the mobile terminal 710 through the communications unit 901.

Each of the knowledge estimation unit 1005, the sentence obtainment unit 1007, the sentence summarization unit 1008, and the summary word generation unit 1010 may be a program module implemented by, for example, the controller 903 executing a summary generation program stored in the storage unit 902. Moreover, the position information saving unit 1001, the operation history saving unit 1003, the knowledge estimation rule saving unit 1004, the knowledge information saving unit 1006, and the concept information saving unit 1009 may be included in, for example, the storage unit 902 as appropriate. Alternatively, these functional units may be implemented by a logic circuit (hardware) fabricated, for example, in the form of an integrated circuit (an IC chip). Each of the functional units may be implemented by one or more integrated circuits. Two or more of such functional circuits may be implemented by a single integrated circuit.

Operations of Mobile Terminal 710 and Summary Generation Server 740

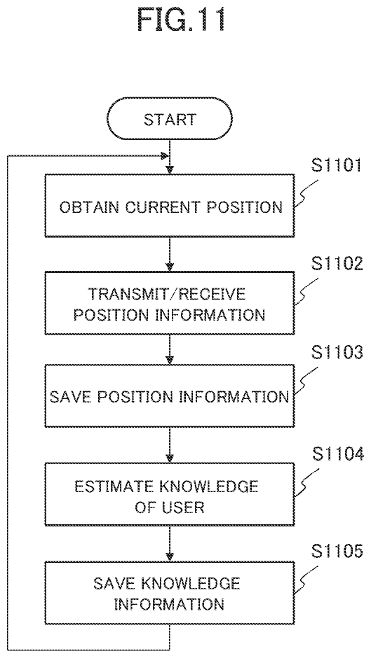

Described next are operations of the mobile terminal 710 and the summary generation server 740, with reference to FIGS. 11 to 13.

FIG. 11 is a flowchart showing an example of a method, for estimating user knowledge, included in a summary generation method according to the second embodiment. This method for estimating user knowledge involves estimating knowledge of a user, using position information on the mobile terminal 710.

At S1101, the position information obtainment unit 706 of the mobile terminal 710 obtains a current position of the mobile terminal 710.

Next, at S1102, the position information obtainment unit 706 of the mobile terminal 710 transmits information on the obtained current position (position information), together with such information as date-time information indicating the date and time when the position information is obtained and identification information for identifying the mobile terminal 710 and the user, through the communications unit 701 of the mobile terminal 710 to the summary generation server 740. The communications unit 901 of the summary generation server 740 receives such information as the position information, the date-time information, and the identification information transmitted by the mobile terminal 710.

Next, at S1103, the communications unit 901 of the summary generation server 740 saves, on the position information saving unit 1001, such received information as the position information, the date-time information, and the identification information.

At S1104, the knowledge estimation unit 1005 of the summary generation server 740 estimates knowledge of the user (knowledge information) in accordance at least with the position information saved on the position information saving unit 1001 and a knowledge estimation rule saved on the knowledge estimation rule saving unit 1004.

Next, at S1105, the knowledge estimation unit 1005 of the summary generation server 740 saves, on the knowledge information saving unit 1006, the estimated knowledge information.

The mobile terminal 710 and the summary generation server 740 periodically repeat (e.g., every one minute or every one hour) the processes of S1101 to S1105. Hence, the summary generation server 740 accumulates the knowledge information in the knowledge information saving unit 1006.

Note that the processes of S1101 to S1103 and the processes of S1104 and S1105 may be performed separately. For example, the processes of S1101 to S1103 may be performed every one minute, and the processes of S1104 and S1105 may be performed every one hour.

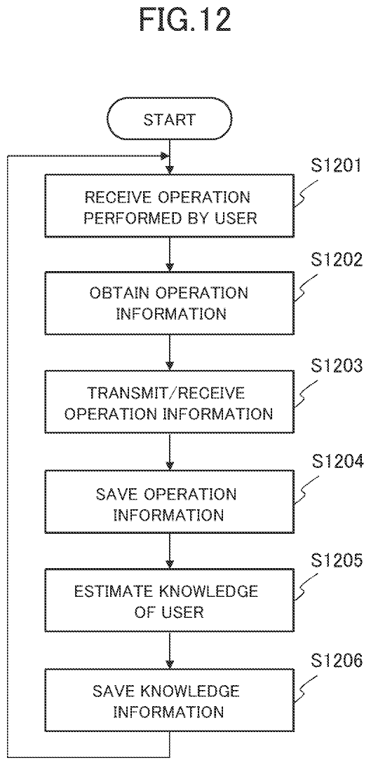

FIG. 12 is a flowchart showing another example of the method, for estimating user knowledge, included in the summary generation method according to the second embodiment. This method for estimating user knowledge involves estimating knowledge of a user, using information on an operation of the mobile terminal 710 performed by the user.

At S1201, the user operates the mobile terminal 710, using the input unit 704 of the mobile terminal 710. That is, the input unit 704 of the mobile terminal 710 receives an operation performed by the user.

Nest, at S1202, the operation information obtainment unit 802 of the mobile terminal 710 obtains information on the operation (operation information) performed with the input unit 704 of the mobile terminal 710.

Next, at S1203, the operation information obtainment unit 802 of the mobile terminal 710 transmits the obtained operation information, together with such information as date-time information indicating when the operation information is obtained and identification information for identifying the mobile terminal 710 and the user, through the communications unit 701 of the mobile terminal 710 to the summary generation server 740. The communications unit 901 of the summary generation server 740 receives such information as the operation information, the date-time information, and the identification information transmitted by the mobile terminal 710.

Next, at S1204, the communications unit 901 of the summary generation server 740 saves, on the operation history saving unit 1003, such received information as the operation information, the date-time information, and the identification information.

At S1205, the knowledge estimation unit 1005 of the summary generation server 740 estimates knowledge of the user (knowledge information) in accordance at least with the operation information saved on the operation history saving unit 1003 and a knowledge estimation rule saved on the knowledge estimation rule saving unit 1004.

Next, at S1206, the knowledge estimation unit 1005 of the summary generation server 740 saves, on the knowledge information saving unit 1006, the estimated knowledge information.

The mobile terminal 710 performs processes of S1201 to S1203 every time the user operates the mobile terminal 710 using the input unit 704 of the mobile terminal 710. The summary generation server 740 periodically repeats (e.g., every one minute or every one hour) the processes of S1205 and S1206 to accumulate the knowledge information in the knowledge information saving unit 1206.

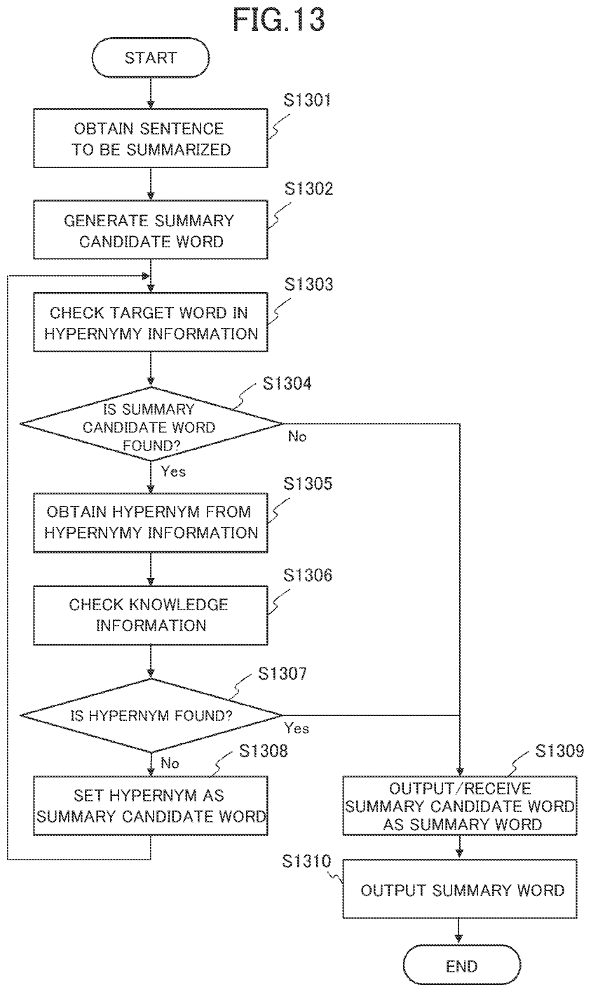

FIG. 13 is a flowchart showing an example of a method, for generating a summary word, included in the summary generation method according to the second embodiment.

At S1301, the sentence obtainment unit 1007 of the summary generation server 740 obtains a sentence distributed to be summarized from the sentence distribution server 730 through the communications unit 901 of the summary generation server 740, and outputs the sentence to the sentence summarization unit 1008 of the summary generation server 740.

At S1302, as described above, the sentence summarization unit 1008 of the summary generation server 740 summarizes the sentence obtained by the sentence obtainment unit 1007, and outputs, to the summary word generation unit 1010 of the summary generation server 740, a summary candidate word as a result of the summarization.

At S1303, the summary word generation unit 1010 of the summary generation server 740 checks whether the summary candidate word is found as a target word in hypernymy information saved on the concept information saving unit 1009 of the summary generation server 740.

If the summary candidate word is not found as a target word in the hypernymy information (No at S1304), the summary word generation unit 1010 of the summary generation server 740 at S1309 sets the summary candidate word as a summary word, and outputs the summary candidate word set as the summary word to the mobile terminal 710 through the communications unit 901 of the summary generation server 740. Next, at S1310, the output unit 705 of the mobile terminal 710 receives the summary word through the communications unit 701 of the mobile terminal 710, and outputs to the user the summary word as, for example, display information and/or audio information.

If the summary candidate word is found as a target word in the hypernymy information (Yes at S1304), the summary word generation unit 1010 of the summary generation server 740 obtains at S1305 a hypernym of the target word from the hypernymy information.

At S1306, the summary word generation unit 1010 of the summary generation server 740 checks whether the obtained hypernym is found as knowledge information saved on the knowledge information saving unit 1006 of the summary generation server 740.

If the hypernym is found as the knowledge information (Yes at S1307), the summary word generation unit 1010 of the summary generation server 740 at S1309 sets the summary candidate word as a summary word, and transmits the summary candidate word set as the summary word to the mobile terminal 710 through the communications unit 901 of the summary generation server 740. Next, at S1310, the output unit 705 of the mobile terminal 710 receives the summary word through the communications unit 701 of the mobile terminal 710, and outputs to the user the summary word as, for example, display information and/or audio information.

If the hypernym is not found as the knowledge information (No at S1307), the summary word generation unit 1010 of the summary generation server 740 sets at S1308 the hypernym as a new summary candidate word. After that, the summary word generation unit 1010 of the summary generation server 740 performs the processes from S1303 again.

This embodiment also makes it possible to achieve the same advantageous effects as those of the first embodiment.

The embodiments of the present invention also relate to a summary generation program. As can be seen, the summary generation program may be stored not only in the storage unit 202 of the summary generation apparatus 110 or in the storage unit 902 of the summary generation apparatus 740, but also in another storage apparatus or a storage medium. Alternatively, the summary generation program may be transmitted through a network. When executed by the controller 203 of the summary generation apparatus 110 or the controller 903 of the summary generation apparatus 740, the summary generation program may cause the summary generation apparatus 110 or the summary generation apparatus 740; namely, a computer, to function as the above functional units. In other words, when executed by the controller 203 of the summary generation apparatus 110 or the controller 903 of the summary generation apparatus 740, the summary generation program may cause the summary generation apparatus 110 or the summary generation apparatus 740; namely, a computer, to execute steps of the above method. The embodiments of the present invention also relate to a storage apparatus or a storage medium containing the above summary generation program.

In relation to the above embodiments, the present invention further discloses the additional remarks below.

Additional Remark 1 A summary generation apparatus includes:

a knowledge estimation unit estimating user knowledge in accordance with a knowledge estimation rule for estimating that a user has knowledge;

a sentence obtainment unit obtaining a sentence to be summarized;

a sentence summarization unit summarizing the sentence obtained by the sentence obtainment unit to obtain a summary candidate word as a result of the summarization; and

a summary word generation unit generating a summary word to be output to the user in accordance with the user knowledge estimated by the knowledge estimation unit and the summary candidate word obtained by the sentence summarization unit.

Additional Remark 2

In the summary generation apparatus according to Additional Remark 1, in hypernymy information previously set and including a pair of a first word and a second word representing a hypernymy of the first word, if the summary candidate word is not found as the first word, the summary word generation unit sets the summary candidate word as the summary word.

Additional Remark 3

In the summary generation apparatus according to Additional Remark 1, in hypernymy information previously set and including a pair of a first word and a second word representing a hypernymy of the first word, if the summary candidate word is found as the first word and the second word is found as the user knowledge estimated by the knowledge estimation unit, the summary word generation unit sets the summary candidate word as the summary word.

Additional Remark 4

In the summary generation apparatus according to Additional Remark 1, in hypernymy information previously set and including a pair of a first word and a second word representing a hypernymy of the first word, if the summary candidate word is found as the first word and the second word is not found as the user knowledge estimated by the knowledge estimation unit, the summary word generation unit (i) sets the second word as a new summary candidate word, and (ii) generates the summary word in accordance with the user knowledge estimated by the knowledge estimation unit and the new summary candidate word.

Additional Remark 5

The summary generation apparatus according to any one of Additional Remarks 1 to 4, further includes

a position information obtainment unit obtaining information on a current position of the summary generation apparatus, wherein

the knowledge estimation unit estimates the user knowledge in accordance with the knowledge estimation rule and the information on the current position obtained by the position information obtainment unit.

Additional Remark 6

The summary generation apparatus according to any one of Additional Remarks 1 to 4, further includes:

an input unit performing an input to the summary generation apparatus; and

an operation information obtainment unit obtaining information on an operation performed on the summary generation apparatus through the input unit, wherein

the knowledge estimation unit estimates the user knowledge in accordance with the knowledge estimation rule and the information on the operation obtained by the operation information obtainment unit.

Additional Remark 7

The summary generation apparatus according to any one of Additional Remarks 1 to 4, further includes:

a communications unit receiving information, from a terminal of the user, on a current position of the terminal, wherein

the knowledge estimation unit estimates the user knowledge in accordance with the knowledge estimation rule and the information on the current position received by the communications unit.

Additional Remark 8

The summary generation apparatus according to any one of Additional Remarks 1 to 4, further includes:

a communications unit receiving information, on an operation performed on a terminal of the user, from the terminal through an input unit included in the terminal, wherein

the knowledge estimation unit estimates the user knowledge in accordance with the knowledge estimation rule and the information on the operation received by the communications unit.

Additional Remark 9

A summary generation method, executed by a summary generation apparatus, includes:

estimating, by the summary generation apparatus, user knowledge in accordance with a knowledge estimation rule for estimating that a user has knowledge;

obtaining, by the summary generation apparatus, a sentence to be summarized;

summarizing, by the summary generation apparatus, the sentence to obtain a summary candidate word as a result of the summarization; and

generating, by the summary generation apparatus, a summary word to be output to the user in accordance with the user knowledge and the summary candidate word.

Additional Remark 10

A program causing a computer to execute:

estimating user knowledge in accordance with a knowledge estimation rule for estimating that a user has knowledge;

obtaining a sentence to be summarized;

summarizing the sentence to obtain a summary candidate word as a result of the summarization; and

generating a summary word to be output to the user in accordance with the user knowledge and the summary candidate word.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A summary generation apparatus, comprising:
a knowledge estimation unit configured to estimate user knowledge in accordance with a knowledge estimation rule for estimating that a user has knowledge;
a sentence obtainment unit configured to obtain a sentence to be summarized;
a sentence summarization unit configured to summarize the sentence obtained by the sentence obtainment unit to obtain a summary candidate word as a result of the summarization; and
a summary word generation unit configured to generate a summary word to be output to the user in accordance with the user knowledge estimated by the knowledge estimation unit and the summary candidate word obtained by the sentence summarization unit.

2. The summary generation apparatus according to claim 1, wherein
in hypernymy information previously set and including a pair of a first word and a second word representing a hypernymy of the first word, if the summary candidate word is not found as the first word, the summary word generation unit sets the summary candidate word as the summary word.

3. The summary generation apparatus according to claim 1, wherein
in hypernymy information previously set and including a pair of a first word and a second word representing a hypernymy of the first word, if the summary candidate word is found as the first word and the second word is found as the user knowledge estimated by the knowledge estimation unit, the summary word generation unit sets the summary candidate word as the summary word.

4. The summary generation apparatus according to claim 1, wherein
in hypernymy information previously set and including a pair of a first word and a second word representing a hypernymy of the first word, if the summary candidate word is found as the first word and the second word is not found as the user knowledge estimated by the knowledge estimation unit, the summary word generation unit (i) sets the second word as a new summary candidate word, and (ii) generates the summary word in accordance with the user knowledge estimated by the knowledge estimation unit and the new summary candidate word.

5. The summary generation apparatus according to claim 1, further comprising
a position information obtainment unit configured to obtain information on a current position of the summary generation apparatus, wherein
the knowledge estimation unit estimates the user knowledge in accordance with the knowledge estimation rule and the information on the current position obtained by the position information obtainment unit.

6. The summary generation apparatus according to claim 1, further comprising:
an input unit configured to perform an input to the summary generation apparatus; and
an operation information obtainment unit configured to obtain information on an operation performed on the summary generation apparatus through the input unit, wherein
the knowledge estimation unit estimates the user knowledge in accordance with the knowledge estimation rule and the information on the operation obtained by the operation information obtainment unit.

7. The summary generation apparatus according to claim 1, further comprising
a communications unit configured to receive information, from a terminal of the user, on a current position of the terminal, wherein
the knowledge estimation unit estimates the user knowledge in accordance with the knowledge estimation rule and the information on the current position received by the communications unit.

8. The summary generation apparatus according to claim 1, further comprising:
a communications unit configured to receive information, on an operation performed on a terminal of the user, from the terminal through an input unit included in the terminal, wherein
the knowledge estimation unit estimates the user knowledge in accordance with the knowledge estimation rule and the information on the operation received by the communications unit.

9. A summary generation method executed by a summary generation apparatus, the summary generation method comprising:
estimating, by the summary generation apparatus, user knowledge in accordance with a knowledge estimation rule for estimating that a user has knowledge;
obtaining, by the summary generation apparatus, a sentence to be summarized;
summarizing, by the summary generation apparatus, the sentence to obtain a summary candidate word as a result of the summarization; and
generating, by the summary generation apparatus, a summary word to be output to the user in accordance with the user knowledge and the summary candidate word.

10. A non-transitory computer-readable storage medium containing a program causing a computer to execute:
estimating user knowledge in accordance with a knowledge estimation rule for estimating that a user has knowledge;
obtaining a sentence to be summarized;
summarizing the sentence to obtain a summary candidate word as a result of the summarization; and
generating a summary word to be output to the user in accordance with the user knowledge and the summary candidate word.
